(19) United States
(12) Patent Application Publication
(10) Pub. No.: US 2024/0054672 A1
(43) Pub. Date: Feb. 15, 2024

(54) DETERMINATION SYSTEM, DETERMINATION METHOD, AND RECORDING MEDIUM

(71) Applicant: Panasonic Intellectual Property Management Co., Ltd., Osaka (JP)

(72) Inventors: Souksakhone BOUNYONG, Osaka (JP); Mototaka YOSHIOKA, Osaka (JP)

(21) Appl. No.: 18/260,414

(22) PCT Filed: Dec. 24, 2021
(86) PCT No.: PCT/JP2021/048114

§ 371 Date: Jul. 5, 2023

(30) Foreign Application Priority Data
Mar. 10, 2021 (JP) 2021-038180

(51) Int. Cl. G06T 7/70; G06T 7/194; G06T 7/20

(52) U.S. Cl. CPC G06T 7/70; G06T 7/194; G06T 7/20

(57) ABSTRACT

A determination system is an operation device that determines whether a posture of a subject who uses a terminal device is a good posture or a poor posture. The determination system includes: an obtainer that obtains an image including a background part behind the subject from an imaging device provided in the terminal device; and a determiner that determines whether a posture of the subject is the good posture or the poor posture based on the background part included in the image obtained, and outputs a determination result.

### CROSS-REFERENCE OF RELATED APPLICATIONS

This application is the U.S. National Phase under 35 U.S.C. § 371 of International Patent Application No. PCT/JP2021/048114, filed on Dec. 24, 2021, which in turn claims the benefit of Japanese Patent Application No. 2021-038180, filed on Mar. 10, 2021, the entire disclosures of which Applications are incorporated by reference herein.

### TECHNICAL FIELD

The present disclosure relates to a determination system, a determination method, and a recording medium for executing the determination method using a computer.

### BACKGROUND ART

Nowadays, an environment capable of carrying out various types of work related to a communication destination using communications through a network while staying at home has been sought after. Meanwhile, being able to work at home may worsen the posture taken during work, and this may result in a decrease in work efficiency. In this regard, a learning assistance system and the like that cause a person to take a good posture during learning, which is one example of the various types of work, has been known.

### CITATION LIST

### Patent Literature

[PTL 1] Japanese Unexamined Patent Application Publication No. 2019-82311

### SUMMARY OF INVENTION

### Technical Problem

However, since there are cases where conventional systems such as the above-mentioned learning assistance system cannot correctly determine the posture, these conventional systems may be insufficient to cause a subject to work in an appropriate posture.

In view of the above, the present disclosure provides a determination system and the like that can more appropriately determine the posture of a subject.

### Solution to Problem

In order to provide a determination system as described above, a determination system according to one aspect of the present disclosure is a determination system that determines whether a posture of a subject who uses a terminal device is a good posture or a poor posture. The determination system includes: an obtainer that obtains an image including a background part behind the subject from an imaging device provided in the terminal device; and a determiner that determines whether a posture of the subject is the good posture or the poor posture based on the background part included in the image obtained, and outputs a determination result.

In addition, a determination method according to one aspect of the present disclosure is a determination method for determining whether a posture of a subject who uses a terminal device is a good posture or a poor posture. The determination method includes: obtaining an image including a background part behind the subject from an imaging device provided in the terminal device; and determining whether a posture of the subject is the good posture or the poor posture based on the background part included in the image obtained to output a determination result.

Moreover, one aspect of the present disclosure can be implemented as a program for causing a computer to execute the above-described determination method. Alternatively, one aspect of the present disclosure may be implemented as a non-transitory computer-readable recording medium that stores the program.

### Advantageous Effects of Invention

The present disclosure can more appropriately determine the posture of a subject.

### BRIEF DESCRIPTION OF DRAWINGS

FIG. 1 is a diagram illustrating an example of usage of a determination system according to an embodiment.

FIG. 2 is a functional block diagram illustrating the determination system and peripheral devices according to Embodiment 1.

FIG. 3 is a schematic diagram illustrating an image obtained by an obtainer according to Embodiment 1.

FIG. 4 is a block diagram illustrating details of a determiner according to Embodiment 1.

FIG. 5 is a flowchart illustrating operations of the determination system according to Embodiment 1.

FIG. 6 is a block diagram illustrating details of a determiner according to Embodiment 2.

FIG. 7 is a flowchart illustrating operations of a determination system according to Embodiment 2.

FIG. 8 is a block diagram illustrating details of a determiner according to Embodiment 3.

FIG. 9A is a first schematic diagram illustrating an image obtained by an obtainer according to Embodiment 3.

FIG. 9B is a second schematic diagram illustrating an image obtained by the obtainer according to Embodiment 3.

FIG. 10 is a flowchart illustrating operations of a determination system according to Embodiment 3.

### DESCRIPTION OF EMBODIMENTS

(Circumstances Leading to the Present Disclosure) In order to determine the posture of a subject, a system that captures an image of the subject and compares the image with data indicating a good posture to determine whether the posture of the subject is good or poor has been conventionally known (for example, see PTL 1). Moreover, various types of work (also called tasks) related to a communication destination can be carried out using communications through a network while staying at home nowadays.

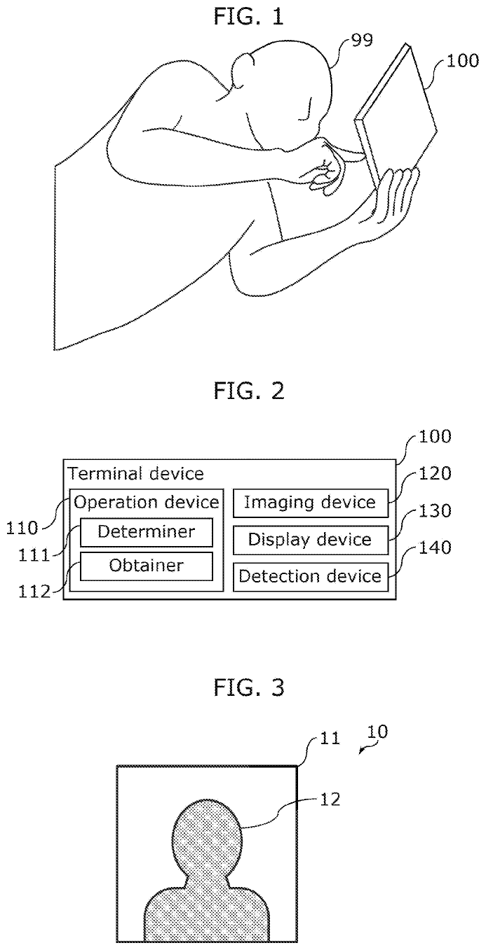

Here, FIG. 1 is a diagram illustrating an example of usage of a determination system according to an embodiment. Subject 99 does not need to work at an assigned desk. For example, as illustrated in FIG. 1, subject 99 can work, at home, in a posture lying (lying posture) on bedding or the like with terminal device 100 of a portable type such as a tablet terminal. Since the posture as described above is unsuitable for working, it is suitable to provide a notification such as a warning to take a normal posture. However, conventional systems falsely recognize the above-described posture as a good posture since the torso part such as back muscles of subject 99 matches a normal posture when an image of the posture of subject 99 is captured.

In view of the above, the present disclosure provides a determination system that obtains the background part behind subject 99 which is captured in an image to determine whether the posture of subject 99 is good or poor based on the background part. Since this determination system can correctly determine a poor posture such as a lying posture taken by subject 99 as a poor posture, the posture of the subject can be more appropriately determined.

Hereinafter, embodiments of the present disclosure will be described with reference to the drawings. Note that the embodiments below each show a general or specific example of the present disclosure. The numerical values, structural elements, the arrangement and connection of the structural elements, steps, the orders of the steps, and the like described in the following embodiments are mere examples, and thus are not intended to limit the present disclosure. Therefore, among the structural elements in the following embodiments, structural elements not recited in any of the independent claims of the present disclosure are described as optional structural elements.

In addition, the drawings are schematic diagrams, and do not necessarily provide strictly accurate illustration. Accordingly, the drawings do not necessarily coincide with each other in terms of scales and the like. Throughout the drawings, the same reference numeral is given to substantially the same element, and redundant descriptions may be omitted or simplified.

### Embodiment 1

### [Configuration of Determination System]

First, a determination system according to Embodiment 1 will be described with reference to FIG. 2. FIG. 2 is a functional block diagram illustrating a determination system and peripheral devices according to Embodiment 1.

The determination system according to the embodiment is implemented by being provided inside terminal device 100. Specifically, the determination system according to the embodiment is implemented by operation device 110 provided inside terminal device 100. Note that functions of the determination system may be implemented by a cloud server on a network, an edge server, or the like. In this case, the determination system may be located at a physically distant position from terminal device 100 through a network.

As illustrated in FIG. 2, terminal device 100 includes operation device 110, imaging device 120, display device 130, and detection device 140.

Operation device 110 is one example of the determination system as described above, and is implemented by execution of a predetermined program using a processor and memory. Operation device 110 includes determiner 111 and obtainer 112. Determiner 111 is a processor that determines whether the posture of subject 99 is good or poor, and outputs a determination result of the determination. Details of determiner 111 will be described later. Obtainer 112 is a processor that obtains an image generated by imaging device 120 imaging a subject, etc. Obtainer 112 has a function of, for example, converting an obtained image into an image that can be used by determiner 111.

Imaging device 120 is a camera of a combination of an optical member such as a lens and a light receiving element, and can generate an image according to received light. Although imaging device 120 may be provided on, for example, both a principal surface of plate-like terminal device 100 which faces subject 99 and a principal surface on the opposite side, imaging device 120 provided on the principal surface facing subject 99 will be described as imaging device 120 in this embodiment. As described above, imaging device 120 generates an image on the subject 99 side by receiving light from the subject 99 side. To be more specific, imaging device 120 generates an image that captures subject 99 and the back of subject 99.

FIG. 3 is a schematic diagram illustrating an image obtained by the obtainer according to Embodiment 1. As illustrated in FIG. 3, the imaged image 10 includes subject part 12 (the part hatched with dots) capturing subject 99 and background part 11 (the white part) capturing the back of subject 99. Note that imaging device 120 may generate image 10 that captures only background part 11 as occasion requires. The above-mentioned example will be described later. Imaging device 120 may have a configuration in which a direction and a zoom scale factor are automatically changeable by a control device, etc. not illustrated, for example.

Display device 130 is a display module using liquid crystal, organic electroluminescence (EL), or the like, and can project image data in a visually recognizable manner. A task carried out by subject 99 is projected onto display device 130 as an image in a graphical user interface (GUI) or the like.

Detection device 140 is a device that obtains, by detection using a pressure-sensitive or capacitance contact sensor, an acceleration sensor, and the like, an input, etc. into terminal device 100 from subject 99. The contact sensors of detection device 140 and the above-described display device 130 together may configure a touch display. For example, an input into terminal device 100 by subject 99 to carry out work is detected via detection device 140. As described above, display device 130 and detection device 140 together allow subject 99 to carry out work using terminal device 100.

### [Determiner]

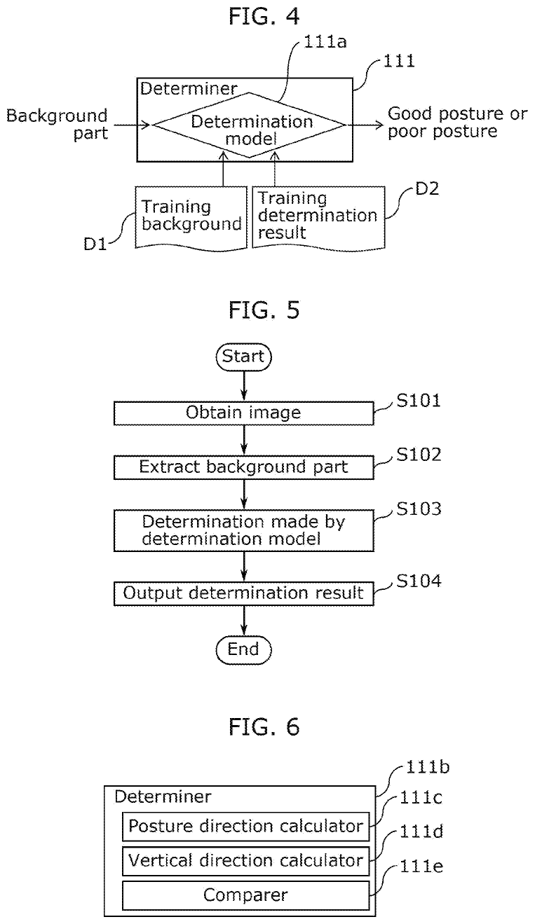

Next, a configuration of determiner 111 according to the embodiment will be described with reference to FIG. 4. FIG. 4 is a block diagram illustrating details of the determiner according to Embodiment 1. As illustrated in FIG. 4, determiner 111 includes determination model 111a. Determination model 111a is a machine learning model that is trained in advance using a combination of training background D1 that is training data corresponding to background part 11 and training determination result D2 that is training data corresponding to a good posture or a poor posture. Determiner 111 inputs background part 11 out of an obtained image 10 into determination model 111a to output, as a determination result, a good posture obtained or a poor posture obtained.

Training here uses, for example, training data that determines the posture of subject 99 is poor based on a fact that training background D1 includes at least a fixed proportion (proportion of pixels) of a lying posture support item such as a floor, a bed, a sofa, and/or a bench that likely to support the lying posture of subject 99. For example, since it is estimated that the posture of subject 99 is poor when flooring or a tatami mat is included in training background D1, training determination result D2 indicating the posture of subject 99 is poor is used for the training in combination with training background D1.

When training background D1 includes an object (i.e., a lying posture support item) such as bedding including a bed, a pillow, etc., the seat and an armrest of a sofa, and/or a bench that include a top surface capable of supporting the lying posture of subject 99, training determination result D2 indicating the posture of subject 99 is poor is used for the training in combination with training background D1. Alternatively, when training background D1 includes a lying posture support item that is slightly captured at a position sufficiently distant from subject 99 in the above-described training, training determination result D2 indicating the posture of subject 99 is good is used for the training in combination with training background D1. The above case corresponds to the case where a lying posture support item occupies a region of less than 20% of background part 11.

As another example of the above-described training, training determination result D2 indicating the posture of subject 99 is poor may be used for training in combination with training background D1 when training background D1 includes approximately 90-degree turn of the following: a window structure in a room where subject 99 is present; the horizon, trees, and the like that can be seen as distant views from the window; and the pattern of walls and the face of a clock.

In this embodiment, the use of the above-described determination model can appropriately determine whether subject 99 is working in a poor posture, such as a lying posture.

### [Operation]

Next, operations performed by the above-described terminal device 100 will be described with reference to FIG. 5. Particularly, operations performed by operation device 110, namely a determination system will be described. FIG. 5 is a flowchart illustrating operations of a determination system according to Embodiment 1.

First, when subject 99 starts working, imaging device 120 is controlled to start imaging a subject, etc. in response to the work. Here, obtainer 112 obtains image 10 generated by imaging device 120 (step S101). Determiner 111 extracts background part 11 from the obtained image 10 (step S102). Determiner 111 further inputs the extracted background part 11 into determination model 111a to determine whether the posture of subject 99 is good or poor (step S103). Thereafter, determiner 111 outputs a determination result (step S104).

The output determination result is notified by, for example, display device 130 of terminal device 100 through a mode such as a pop-up window. From this determination result, subject 99 by themselves can change their posture to a posture that would be determined as a good posture. The determination result may also be notified, through a network, to a manager who manages the progress of work carried out by subject 99 or stored in a storage server or the like.

### [Advantageous Effects, Etc.]

As has been described above, a determination system (operation device 110) is operation device 110 that determines whether a posture of subject 99 who uses terminal device 100 is a good posture or a poor posture. Operation device 110 includes: obtainer 112 that obtains image 10 including background part 11 behind subject 99 from imaging device 120 provided in terminal device 100; and determiner 111 that determines whether a posture of subject 99 is the good posture or the poor posture based on background part 11 included in image 10 obtained, and outputs a determination result.

Operation device 110 as described above can determine whether the posture of subject 99 is good or poor using background part 11 behind subject 99 in image 10. For example, although subject 99 is in a relatively good posture with respect to terminal device 100, background part 11 can reflect, in the determination result, whether the posture of subject 99 is truly a good posture. Therefore, operation device 110 can more appropriately determine the posture of a subject.

In addition, determiner 111 may output, as the determination result, the good posture or the poor posture that is obtained by inputting background part 11 included in the obtained image 10 into determination model 111a trained in advance using a training data set of combinations of training background D1 and training determination result D2, for example. Training background D1 is training data corresponding to background part 11. Training determination result D2 is training data corresponding to the good posture or the poor posture.

With this, whether the posture of subject 99 is good or poor can be obtained by an input of background part 11 of an obtained image 10 into determination model 111a that has been trained using background part 11 showing that subject 99 is in a good posture and background part 11 showing that subject 99 is in a poor posture. A good posture obtained or a poor posture obtained can be output as a determination result. From the above, a determination result close to a determination made by humans can be obtained in a fixed law.

Moreover, the training data set may be a combination of (i) training background D1 and (ii) training determination result D2 indicating the posture of subject 99 is the poor posture based on inclusion, in training background D1, of a lying posture support item supporting a lying posture of subject 99, for example.

With this, it is possible to determine that the posture of subject 99 is poor when background part 11 includes an object such as bedding including a bed, a pillow, etc. and/or a flooring material including a tatami mat, flooring, etc., that can support a lying posture of subject 99 since the foregoing situation has a higher possibility that subject 99 is in a lying posture.

In addition, a determination method according to the embodiment is a determination method for determining whether a posture of subject 99 who uses terminal device 100 is a good posture or a poor posture. The determination method includes: obtaining image 10 including background part 11 behind subject 99 from imaging device 120 provided in terminal device 100; and determining whether a posture of subject 99 is the good posture or the poor posture based on background part 11 included in image 10 obtained to output a determination result.

The determination method as described above can yield the same advantageous effects as the above-described determination system.

Moreover, a recording medium according to the embodiment is a non-transitory computer-readable recording medium on which a program for causing a computer to execute the above-described determination method is recorded.

The recording medium as described above can yield the same advantageous effects as the above-described determination method using a computer.

### Embodiment 2

Next, a determination system according to Embodiment 2 will be described with reference to FIG. 6. FIG. 6 is a block diagram illustrating details of a determiner according to Embodiment 2. Note that Embodiment 2 described below will mainly describe structural elements different from the above-described Embodiment 1, and descriptions of structural elements considered to be substantially the same as Embodiment 1 may be omitted or simplified by, for example, referring to the same reference numerals.

### [Determiner]

In this embodiment, the configuration of determiner 111b is different compared to the above-described Embodiment 1. Determiner 111b according to the embodiment includes posture direction calculator 111c, vertical direction calculator 111d, and comparer 111e. Posture direction calculator 111c is a processor that calculates a posture direction of subject 99 using subject part 12 capturing subject 99 included in image 10. The posture direction is a direction in which the torso part of subject 99 extends when subject 99 is in a posture. For example, the posture direction does not take account of a change in a local posture such as bending of an arm, straightening up of the back, tilting of the neck, and the like. The posture direction is a vector including only a direction component of a direction extending from the waist part to the neck part of subject 99. Posture direction calculator 111c is implemented by, for example, an existing image analysis program that calculates the posture direction from subject part 12.

Vertical direction calculator 111d is a processor that uses background part 11 to calculate a vertical direction of the back part of subject 99. The vertical direction is a vector including only a direction component, and corresponds with the gravity direction. Accordingly, vertical direction calculator 111d calculates the vertical direction by analyzing an image of the horizon, arboreal plants, buildings, etc. captured in background part 11, for example. Vertical direction calculator 111d is implemented by, for example, an existing image analysis program that calculates the vertical direction from background part 11.

Comparer 111e is a processor that compares a calculated posture direction and a calculated vertical direction to calculate a matching degree to which the calculated posture direction and the calculated vertical direction match, and then determines whether the posture of subject 99 is good or poor based on the calculation result. Comparer 111e calculates, as one example of the matching degree, an angle (a second angle to be described later) formed by a posture direction and a vertical direction. In addition, comparer 111e is provided with a threshold for the matching degree. Comparer 111e is provided with the following thresholds as examples of the threshold: (i) +80 degrees through −80 degrees, (ii) +45 degrees through −45 degrees, (iii) +30 degrees through −30 degrees, (iv) +10 degrees through −10 degrees, and (v) +5 degrees through −5 degrees. Comparer 111e compares a calculated matching degree with one of the above thresholds. When the matching degree falls within the range of a given threshold (second threshold to be described later), comparer 111e determines that a posture direction corresponds with a vertical direction. When it is determined that the posture direction corresponds with the vertical direction, the posture of subject 99 is determined as a good posture. Alternatively, when it is determined that the posture direction does not correspond with the vertical direction, the posture of subject 99 is determined as a poor posture. These determinations also apply when subject 99 is in a lying posture and uses terminal device 100 rotated to align with the lying posture.

In this embodiment as has been described above, it is possible to appropriately determine whether subject 99 is working in a poor posture such as a lying posture by determining whether the posture direction of subject 99 matches a vertical direction calculated from background part 11.

### [Operation]

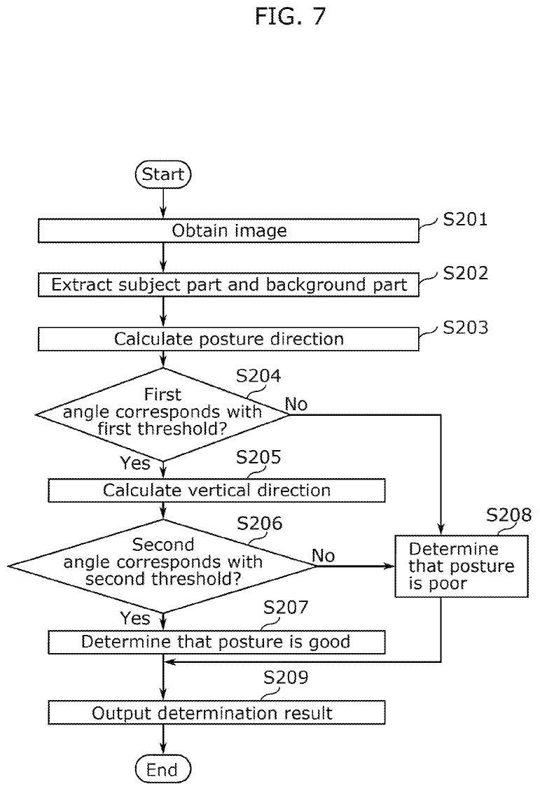

Next, operations performed by the above-described terminal device 100 will be described with reference to FIG. 7. Particularly, operations performed by operation device 110, namely a determination system will be described. FIG. 7 is a flowchart illustrating operations of a determination system according to Embodiment 2.

First, when subject 99 starts working, imaging device 120 is controlled to start capturing images in response to the work. Here, obtainer 112 obtains image 10 generated by imaging device 120 (step S201). Determiner 111b extracts subject part 12 and background part 11 from the obtained image 10 (step S202). Posture direction calculator 111c uses the extracted subject part 12 to calculate a posture direction (step S203). Determiner 111b calculates an angle (first angle) formed by the calculated posture direction and the up-down direction in image 10, and determines whether the angle corresponds with a first threshold (step S204).

Here, the up-down direction in image 10 is a direction based on the up-down direction of content displayed in display device 130 for work carried out. To be more specific, the up-down direction is a direction determined according to the up-down direction of imaging device 120 in terminal device 100 which is oriented according to the up-down direction set to the content. In this case, all of the up-down direction of the content, the up-down direction of imaging device 120, and the up-down direction of image 10 match. When the posture direction corresponds with the up-down direction of image 10, subject 99 is assumed to be at least in an appropriate posture direction with respect to the content. A determination made in step S204 can exclude the case where a posture is apparently a poor posture. For instance, the case where subject 99 is in an inappropriate posture direction with respect to the content can be excluded from step S204.

When determiner 111b determines that the first angle corresponds with the first threshold (Yes in step S204), vertical direction calculator 111d uses background part 11 to calculate a vertical direction (step S205). Thereafter, comparer 111e calculates an angle (second angle) formed by the calculated posture direction and the calculated vertical direction, and determines whether the second angle corresponds with a second threshold (step S206). When comparer 111e determines that the second angle corresponds with the second threshold (Yes in step S206), comparer 111e determines that the posture of subject 99 is good (step S207).

Alternatively, when determiner 111b determines that the first angle does not correspond with the first threshold (No in step S204), and when comparer 111e determines that the second angle does not correspond with the second threshold (No in step S206), the processing proceeds to step S208 and determiner 111b or comparer 111e determines that the posture of subject 99 is poor. Thereafter, determiner 111b outputs the determination result (step S209).

### [Advantageous Effects, Etc.]

As has been described above, in a determination system (operation device 110) according to the embodiment, image 10 further includes subject part 12 capturing subject 99. Determiner 111b extracts each of subject part 12 and background part 11 from image 10, and determines whether the posture of subject 99 is the good posture or the poor posture based on subject part 12 and background part 11.

Operation device 110 as described above can determine whether the posture of subject 99 is good or poor based on background part 11 and subject part 12. Since the posture of subject 99 can also be determined based on subject part 12 even in the case where the posture of subject 99 is determined to be a good posture from background part 11, it is possible to appropriately determine that the posture of subject 99 is poor when subject part 12 etc. show that the posture of subject 99 is actually poor.

In addition, determiner 111b may calculate a posture direction of subject 99 using subject part 12, and may calculate a vertical direction using background part 11. When the vertical direction corresponds with the posture direction, determiner 111b may determine that the posture of subject 99 is the good posture, for example.

With this, it is estimated that terminal device 100 is used in a direction corresponding to a direction in which the torso part of subject 99 extends when the posture direction of subject 99 calculated from subject part 12 corresponds with the vertical direction calculated from background part 11. Since the posture as described above is appropriate for carrying out work using terminal device 100, the posture is determined as a good posture.

Moreover, determiner 111b may calculate a posture direction of subject 99 using subject part 12. When the posture direction corresponds with an up-down direction in image 10, determiner 111b may determine whether the posture of subject 99 is the good posture or the poor posture based on background part 11, for example.

With this, whether a posture of subject 99 is good or poor can be determined using background part 11 only when at least the posture direction of subject 99 corresponds with the up-down direction of image 10. Accordingly, the determination process using background part 11 can be omitted since the posture of subject 99 can be determined to be apparently a poor posture when the posture direction of subject 99 does not correspond with the up-down direction. In this embodiment as has been described above, it is possible to appropriately determine the posture of subject 99 while maintaining a low processing load by omitting and simplifying the determination process.

### Embodiment 3

Next, a determination system according to Embodiment 3 will be described. Note that Embodiment 3 described below will mainly describe structural elements different from the above-described Embodiment 1 or 2, and descriptions of structural elements considered to be substantially the same as Embodiment 1 or 2 may be omitted or simplified by, for example, referring to the same reference numerals.

### [Determiner]

In this embodiment, obtainer 112 consecutively obtains images 10. The embodiment is different compared to the above-described Embodiments 1 and 2 in obtainment of a plurality of images 10. A plurality of images 10 compose moving image 10a that changes in a time sequence (a temporal change). In other words, obtainer 112 according to the embodiment obtains moving image 10a. Note that image 10 in this embodiment means one part of a time base of moving image 10a. Accordingly, image 10 is treated in the same manner as moving image 10a.

In addition, the configuration of determiner 111f is different compared to the above-described Embodiments 1 and 2. Determiner 111f according to the embodiment includes vector calculator 111g and analyzer 111h. Vector calculator 111g is a processor that calculates motion vectors of a plurality of objects in background part 11 based on temporal changes in consecutively obtained background parts 11, namely moving image 10a of background parts 11.

FIG. 9A is a first schematic diagram illustrating an image obtained by an obtainer according to Embodiment 3. In addition, FIG. 9B is a second schematic diagram illustrating an image obtained by the obtainer according to Embodiment 3. FIG. 9A and FIG. 9B each illustrate a schematic diagram of moving image 10a over which calculated motion vectors 13 are superimposed. Note that illustrations of objects generating motion vectors are omitted from FIG. 9A and FIG. 9B.

As illustrated in FIG. 9A and FIG. 9B, motion vectors 13 of objects can be calculated from background parts 11 of moving image 10a based on moving paths taken by the objects, for example. Motion vectors 13 indicate how objects have moved in moving image 10a.

For example, in FIG. 9A, it is evident that subject 99 is moving toward a direction in which imaging device 120 is present since objects move toward the rear of subject 99 behind subject 99.

Meanwhile, since no change in the size and direction of subject 99 can be observed in FIG. 9A, it can be considered that the position of subject 99 relative to the position of imaging device 120 has not been changed.

From the above, subject 99 is estimated to be moving forward carrying terminal device 100 in FIG. 9A. Since subject 99 is moving forward, the posture of subject 99 is assumed to be a poor posture since subject 99 is working while walking or is working in a posture on a mobile body such as a bicycle in FIG. 9A.

For example, in FIG. 9B, it is evident that subject 99 is moving from right to left as viewed from imaging device 120 since objects move in a left-right direction behind subject 99. Meanwhile, since no change in the size and direction of subject 99 can be observed in FIG. 9B, it can be considered that the position of subject 99 relative to the position of imaging device 120 has not been changed.

From the above, subject 99 is estimated to be moving in the left-right direction carrying terminal device 100 in FIG. 9B. Since subject 99 is moving in the left-right direction, subject 99 is working, in the mobile body, facing a direction intersecting the traveling direction of the mobile body. It is estimated that background part 11 shows, for example, views outside a passenger cabin through a window of a train or the like that subject 99 rides. The above-described posture is considered as a good posture. Note that a traveling speed may be considered in order to make the above estimation more certain.

These motion vectors 13 in the examples shown in FIG. 9A and FIG. 9B have a difference in the magnitude of variations in vector directions based on directions in which subject 99 moves. In view of the above, whether the posture of subject 99 is good or poor can be determined by evaluating the magnitude of variations in motion vectors 13 in this embodiment.

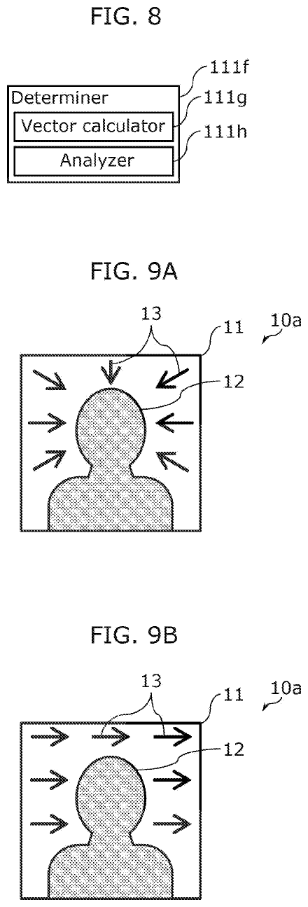

Analyzer 111h will be described with reference to FIG. 8 again. Analyzer 111h is a processor that calculates a variation in directions of motion vectors 13 of objects, and determines that the posture of subject 99 is poor when the calculated variation is greater than a given threshold (third threshold). Analyzer 111h is implemented by an existing numerical analysis program that calculates a variation in directions from a plurality of motion vectors 13, and compares the variation with a threshold, for example.

In this embodiment as has been described above, it is possible to appropriately determine whether subject 99 is working in a poor posture, such as carrying out work using terminal device 100 in an inappropriate posture, by determining the directions and magnitude (i.e., traveling speed) of motion vectors 13 calculated from background parts 11 in moving image 10a.

### [Operation]

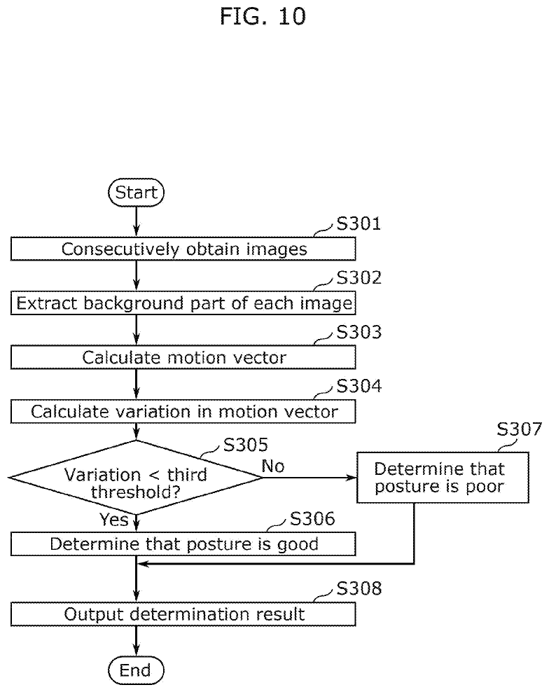

Next, operations performed by the above-described terminal device 100 will be described with reference to FIG. 10. Particularly, operations performed by operation device 110, namely a determination system will be described. FIG. 10 is a flowchart illustrating operations of a determination system according to Embodiment 3.

First, when subject 99 starts working, imaging device 120 is controlled to start capturing images in response to the work. Here, obtainer 112 consecutively obtains images 10 generated by imaging device 120 (step S301). Determiner 111f extracts background part 11 from each of the obtained images 10 (step S302). Vector calculator 111g calculates motion vectors 13 of a plurality of objects in background parts 11 based on background parts 11 composing moving image 10a (step S303). Analyzer 111h calculates a variation in the directions of motion vectors 13 (step S304), and determines whether the variation is less than a third threshold (step S305). When analyzer 111h determines the variation is less than the third threshold (Yes in step S305), analyzer 111h determines that the posture of subject 99 is good (step S306). When analyzer 111h determines the variation is greater than or equal to the third threshold (No in step S305), analyzer 111h determines that the posture of subject 99 is poor (step S307). Thereafter, determiner 111f outputs the determination result (step S308).

### [Advantageous Effects, Etc.]

As has been described above, in a determination system (operation device 110) according to the embodiment, determiner 111f determines whether the posture of subject 99 is the good posture or the poor posture based on a temporal change in consecutively obtained background parts 11. The consecutively obtained background parts 11 each are background part 11.

Operation device 110 as described above can determine whether the posture of subject 99 is good or poor from the viewpoint of how background parts 11 have changed in time domain.

In addition, determiner 111f may calculate motion vectors 13 of objects in the consecutively obtained background parts 11 based on the temporal change in the consecutively obtained background parts 11, may calculate a variation in directions of motion vectors 13 of the objects, and may determine that the posture of subject 99 is the poor posture when the variation is greater than a given threshold, for example.

With this, it is possible to estimate that subject 99 is using terminal device 100 in a poor posture, such as while subject 99 is walking, when a calculated variation in motion vectors 13 is great and subject 99 is moving in a forward-backward direction. When a threshold is set at a speed faster than a bicycle, etc. and slower than an automobile, and motion vectors 13 are generated at a traveling speed greater than the threshold in the above-described determination, it may be determined that the posture of subject 99 is good on the assumption that subject 99 is traveling by an automobile. Alternatively, when a variation of calculated motion vectors 13 is small, it can be estimated that terminal device 100 is used while subject 99 is moving in a fixed direction within a flat surface orthogonal to an imaginary line connecting imaging device 120 and subject 99. Since a movement made by subject 99 as described above likely to occur when subject 99 is a passenger who is not in a position to operate a mobile body such as when subject 99 is seated facing a direction orthogonal to a traveling direction, it is suitable to determine that the posture is good.

### Other Embodiments

Determination systems and the like according to the present disclosure have been hereinbefore described based on the above embodiments, yet the present disclosure is not limited to the above-described embodiments. For example, the present disclosure also encompasses: embodiments achieved by applying various modifications conceivable to those skilled in the art to each embodiment, and embodiments achieved by optionally combining the structural elements and functions of each embodiment without departing from the essence of the present disclosure.

For example, although the above-described embodiments have been described based on the use of a background part as a prerequisite, some of detection devices included in a terminal device may also be used for determining whether the posture of a subject is good or poor in addition to a background part. For example, the position of a terminal device may be detected by a gyro sensor, etc. to adjust the vertical direction calculated in the above Embodiment 2.

In addition, suppose that a background part need not be used since the above-mentioned detection devices are used and that the posture direction of a subject and the up-down direction of content certainly match, whether the posture of the subject is good or poor can be determined without obtaining an image from an imaging device since the posture direction and the vertical direction can be obtained without using an image, for example.

Moreover, the present disclosure can be implemented not only as a determination system, but also as a program including, as steps, processes to be performed by respective structural elements in the determination system and also as a non-transitory computer-readable recording medium on which the above-described program is recorded, for example. The program may be recorded on the recording medium in advance, or may be supplied to the recording medium through a wide area network including, for example, the Internet.

In other words, these general or specific aspects described above may be implemented by a system, a device, an integrated circuit, a computer program, or a non-transitory computer-readable recording medium, or by any optional combination of systems, devices, integrated circuits, computer programs, and recording media.

### INDUSTRIAL APPLICABILITY

The determination systems, etc. according to the present disclosure are provided inside buildings such as homes, offices, and after-school preparatory schools and inside mobile bodies such as vehicles and the like for a purpose of, for example, appropriately determining the posture of a subject.

### REFERENCE SIGNS LIST

10 image
10a moving image
11 background part
12 subject part
13 motion vector
99 subject
D1 training background
D2 training determination result
100 terminal device
110 operation device
111, 111b, 111f determiner
111a determination model
111c posture direction calculator
111d vertical direction calculator
111e comparer
111g vector calculator
111h analyzer
112 obtainer
120 imaging device
130 display device
140 detection device

1. A determination system that determines whether a posture of a subject who uses a terminal device is a good posture or a poor posture, the determination system comprising:
an obtainer that obtains an image including a background part behind the subject from an imaging device provided in the terminal device; and
a determiner that determines whether a posture of the subject is the good posture or the poor posture based on the background part included in the image obtained, and outputs a determination result.

2. The determination system according to claim 1, wherein
the determiner outputs, as the determination result, the good posture or the poor posture that is obtained by inputting the background part included in the image obtained into a determination model trained in advance using a training data set of combinations of a training background and a training determination result, the training background being training data corresponding to the background part, the training determination result being training data corresponding to the good posture or the poor posture.

3. The determination system according to claim 2, wherein
the training data set is a combination of (i) the training background and (ii) the training determination result indicating the posture of the subject is the poor posture based on inclusion, in the training background, of a lying posture support item supporting a lying posture of the subject.

4. The determination system according to claim 1, wherein
the determiner determines whether the posture of the subject is the good posture or the poor posture based on a temporal change in consecutively obtained background parts, the consecutively obtained background parts each being the background part.

5. The determination system according to claim 4, wherein
the determiner:
calculates motion vectors of objects in the consecutively obtained background parts based on the temporal change in the consecutively obtained background parts;
calculates a variation in directions of the motion vectors of the objects; and
determines that the posture of the subject is the poor posture when the variation is greater than a given threshold.

6. The determination system according to claim 1, wherein
the image further includes a subject part capturing the subject, and
the determiner:
extracts each of the subject part and the background part from the image; and
determines whether the posture of the subject is the good posture or the poor posture based on the subject part and the background part.

7. The determination system according to claim 6, wherein
the determiner:
calculates a posture direction of the subject using the subject part;
calculates a vertical direction using the background part; and
when the vertical direction corresponds with the posture direction, determines that the posture of the subject is the good posture.

8. The determination system according to claim 6, wherein
the determiner:
calculates a posture direction of the subject using the subject part; and
when the posture direction corresponds with an up-down direction in the image, determines whether the posture of the subject is the good posture or the poor posture based on the background part.

9. A determination method for determining whether a posture of a subject who uses a terminal device is a good posture or a poor posture, the determination method comprising:
obtaining an image including a background part behind the subject from an imaging device provided in the terminal device; and
determining whether a posture of the subject is the good posture or the poor posture based on the background part included in the image obtained to output a determination result.

10. A non-transitory computer-readable recording medium for use in a computer, the recording medium having recorded thereon a program for causing the computer to execute the determination method according to claim 9.
